(19) United States
(12) Patent Application Publication
(10) Pub. No.: US 2019/0382047 A1
(43) Pub. Date: Dec. 19, 2019

(54) POWER STEERING APPARATUS

(71) Applicant: HITACHI AUTOMOTIVE SYSTEMS, LTD., Hitachinaka-shi, Ibaraki (JP)

(72) Inventors: Osamu YOSHIDA, Yokohama-shi, Kanagawa (JP); Tatsuyoshi MARUYAMA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/479,512

(22) PCT Filed: Nov. 10, 2017
(86) PCT No.: PCT/JP2017/040615

§ 371 Date: Jul. 19, 2019

(30) Foreign Application Priority Data
Jan. 20, 2017 (JP) 2017-008012

(51) Int. Cl. B62D 5/04; F16H 25/22; F16C 19/06; F16C 35/077

(52) U.S. Cl. CPC B62D 5/0448; F16C 35/077; F16C 19/06; F16H 25/2219

(57) ABSTRACT

In a power steering apparatus according to the present invention, regarding a lock nut (12) serving as a fixing member, a fixing portion (122) for fixing an outer race (111) of a ball bearing (11) has a portion which overlaps with a facing portion (121) facing the outer race (111) in the direction of a rotation axis (Z) of a nut (941), and is provided radially on an outer side than the facing portion (121). Accordingly, the projection amount of the lock nut (12) toward an output-side pulley (92) is suppressed and the output-side pulley (92) and a belt (93) can be arranged closer to the ball bearing (11) side, as a result of which friction in the ball bearing (11) can be reduced.

### TECHNICAL FIELD

The present invention relates to a power steering apparatus.

### BACKGROUND TECHNOLOGY

As a conventional power steering apparatus, for example, one described in the following patent document has been known.

That is, in the power steering apparatus according to this patent document, an outer race of a ball bearing pivotally supporting a ball nut rotating integrally with a pulley is fixed to a housing with a lock nut that is a fixing member. In addition, this lock nut is one for fixing the outer race to the housing by being screwed from the pulley side, and a screw portion serving as a fixing portion is provided to extend more on the pulley side than a facing portion facing the outer race.

### PRIOR ART DOCUMENT

### Patent Document

Patent Document 1: Japanese Patent Application Publication 2015-160493

### SUMMARY OF THE INVENTION

### Problem to be Solved by the Invention

However, in a case of the conventional power steering apparatus, since the fixing portion of the lock nut extends toward the pulley, the distance between the ball bearing and the pulley becomes long. Consequently, there is a problem that due to the tension of a belt wound around the pulley, a moment that acts on the ball bearing increases, and friction in the ball bearing increases.

The present invention has been made in consideration of such a technical problem, and an object of the present invention is to provide a power steering apparatus capable of reducing friction in a ball bearing.

### Means for Solving the Problem

In the present invention, as one aspect thereof, in a direction of a rotation axis of a nut, a fixing portion of a fixing member is provided radially on an outer side than a facing portion of the fixing member which faces an outer race.

### Effect of the Invention

According to the present invention, the friction in the ball bearing can be reduced.

### BRIEF DESCRIPTION OF THE DRAWINGS

FIG. 1 is a front view of a power steering apparatus according to the present invention.

FIG. 2 is a sectional view near a transmission mechanism shown in FIG. 1.

FIG. 3 is a main part enlarged view of a first embodiment of the present invention shown in FIG. 2.

FIG. 4 is a main part enlarged view of FIG. 3.

FIG. 5 is a drawing showing a lock nut shown in FIG. 4, and FIG. 5(a) is a perspective view and FIG. 5(b) is a longitudinal sectional view.

FIG. 6 is a drawing showing a wave washer, and FIG. 6(a) is a plane view and FIG. 6(b) is a longitudinal sectional view.

FIG. 7 is a sectional view showing a state at the time of assembling of the lock nut shown in FIG. 4 with a fastening tool.

FIG. 8(a) is an enlarged sectional view near a ball bearing in a conventional power steering apparatus, and FIG. 8(b) is an enlarged sectional view near a ball bearing in the power steering apparatus of the present invention.

FIG. 9 is an enlarged sectional view near a ball bearing of a second embodiment of the present invention that corresponds to the ball bearing of FIG. 3.

FIG. 10 is an enlarged sectional view near a ball bearing of a third embodiment of the present invention that corresponds to the ball bearing of FIG. 3.

### MODE FOR IMPLEMENTING THE INVENTION

In the following, an embodiment of a power steering apparatus according to the present invention will be explained in detail with reference to the drawings. In addition, in the following embodiment, similar to a conventional one, one has been shown in which the power steering apparatus is applied to a steering apparatus of an automobile.

### First Embodiment

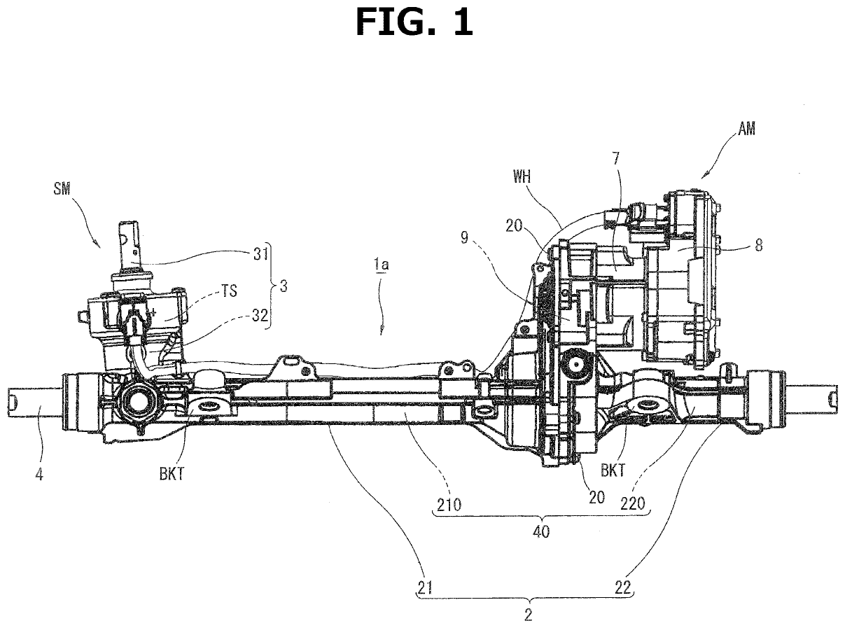

FIG. 1 to FIG. 7 each show a first embodiment of a power steering apparatus according to the present invention.

### Configuration of Power Steering Apparatus

FIG. 1 shows a front view of a power steering apparatus 1a according to a first embodiment of the present invention.

As shown in FIG. 1, the power steering apparatus 1a is equipped with a steering mechanism SM used for steering based on a steering operation by a driver, and a steering assist mechanism AM for assisting the steering operation of the driver. Then, this power steering apparatus 1a is suspended to a body of an automobile, through a bracket BKT attached to a rack housing 2 for accommodating the steering mechanism SM.

The steering mechanism SM includes a steering shaft 3 connected with a steering wheel which is not shown in the drawings and a rack bar 4 as a turning shaft linked with turning wheels which are not shown in the drawings, and the steering shaft 3 and the rack bar 4 are linked with each other through a conversion mechanism which is not shown in the drawings. The conversion mechanism is a so-called rack-pinion mechanism, and is configured of pinion teeth formed to the steering shaft 3 (the after-mentioned output shaft 32), which are not shown in the drawings, and of rack teeth formed to the rack bar 4, which are not shown in the drawings.

The steering shaft 3 is configured by connecting an input shaft 31 rotating integrally with the steering wheel which is not shown in the drawings and the output shaft 32 linked with the rack bar 4 by a torsion bar which is not shown in the drawings. In the input shaft 31, one end side in the axial direction thereof (upper end side in FIG. 1) is connected to the steering wheel which is not shown in the drawings, and the other end side is connected to the torsion bar which is not shown in the drawings. In the output shaft 32, one end side in the axial direction thereof (upper end side in FIG. 1) is connected to the torsion bar which is not shown in the drawings, and the other end side is linked with the rack bar 4. That is, the pinion teeth which are not shown in the drawings are formed on the outer periphery on the other end side of the output shaft 32, and these pinion teeth mesh with the rack teeth of the rack bar 4 which are not shown in the drawings, and consequently, the rotation of the output shaft 32 can be transmitted by being converted to the axial movement of the rack bar 4. In addition, a torque sensor TS for detecting a steering torque input to the steering shaft 3 by the driver is arranged on the outer peripheral side of the steering shaft 3. The torque sensor TS detects the steering torque based on a displacement amount of the relative rotation of the input shaft 31 and the output shaft 32.

In the rack bar 4, the both end portions thereof are linked with the right and left turning wheels which are not shown in the drawings, through tie rods and knuckle arms which are not shown in the drawings. That is, the rack bar 4 moves in the axial direction, and the knuckle arms which are not shown in the drawings are pushed or pulled through the tie rods which are not shown in the drawings, and the direction of the turning wheels which are not shown in the drawings is changed.

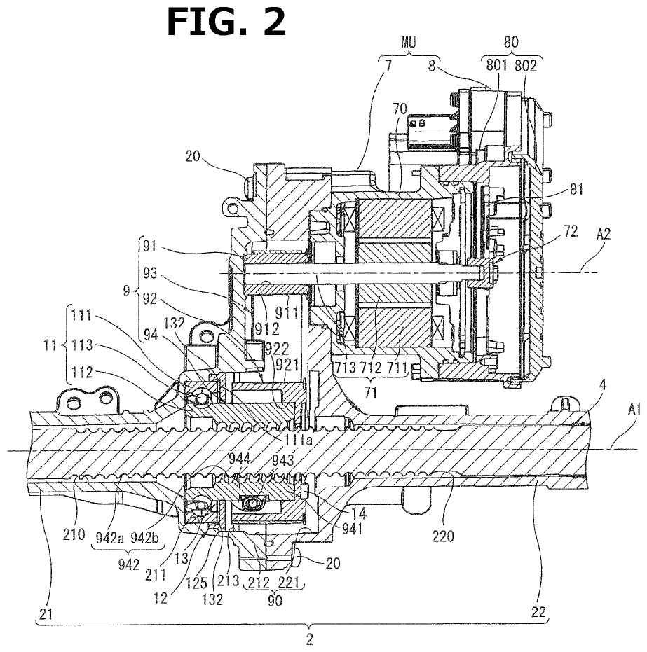

In addition, the rack bar 4 is accommodated in a rack bar accommodation part 40 that is a turning shaft accommodation part penetratingly formed in the substantially cylindrical rack housing 2 so as to be axially movable, in a state in which the both end portions of the rack bar 4 are exposed outside. The rack housing 2 is formed by casting and is axially divided into two parts, and is configured of a first housing 21 accommodating one end side in the axial direction of the rack bar 4 and a second housing 22 accommodating the other end side of the rack bar 4. The first housing 21 and the second housing 22 are fastened to each other by a plurality of bolts 20. In addition, the rack bar accommodation part 40 is configured of a first rack bar accommodation portion 210 penetrating through the inside of the first housing 21 in the axial direction and a second rack bar accommodation portion 220 penetrating through the inside of the second housing 22 in the axial direction (see FIG. 2).

The steering assist mechanism AM includes an electric motor 7 for generating a steering assist force, a control device 8 for controlling the driving of the electric motor 7, and a transmission mechanism 9 for transmitting the driving force of the electric motor 7 to the rack bar 4. That is, the steering assist mechanism AM assists the axial movement of the rack bar 4 with the driving force of the electric motor 7 drivingly controlled by the control device 8 based on detection results of various sensors, such as a vehicle speed sensor which are not shown in the drawings and a torque sensor TS. In addition, by a wire connection, the torque sensor TS is connected to the control device 8 through a harness WH provided along the rack housing 2.

FIG. 2 is a longitudinal sectional view of the power steering apparatus 1a which shows a vicinity of the enlarged transmission mechanism 9. In addition, in the explanation of the present drawing, the direction parallel to a central axis Z of the rack bar 4 is referred to as “axial direction”, the direction orthogonal to the central axis Z of the rack bar 4 is referred to as “radial direction”, and the direction around the central axis Z of the rack bar 4 is referred to as “circumferential direction”.

As shown in FIG. 2, the first housing 21 includes the cylindrical first rack bar accommodation portion 210 accommodating the one end side in the axial direction of the rack bar 4, a deceleration mechanism accommodation part 211 accommodating the after-mentioned ball screw 94, and a first transmission mechanism accommodation portion 212 accommodating a part of the transmission mechanism 9. The first rack bar accommodation portion 210 is formed at the one end side in the axial direction of the first housing 21 (left side in FIG. 2) so as to extend along the axial direction. The deceleration mechanism accommodation part 211 is formed in a step shape such that the diameter thereof is enlarged, through a step portion 211a, at the end portion on the second housing 22 side of the first rack bar accommodation portion 210. The first transmission mechanism accommodation portion 212 has a substantially cup shape opened toward the second housing 22, and is formed extending in a diameter enlarged shape, at the end portion on the second housing 22 side of the after-mentioned female screw portion 215.

The second housing 22 includes the cylindrical second rack bar accommodation potion 220 accommodating the other end side in the axial direction of the rack bar 4 and a second transmission mechanism accommodation portion 221 accommodating a part of the transmission mechanism 9. The second rack bar accommodation portion 220 is formed at the other end side in the axial direction of the second housing 22, so as to extend along the axial direction. The second transmission mechanism accommodation portion 221 has a substantially cup shape opened towered the first housing 21, and is formed extending in a diameter enlarged shape, at the end portion on the first housing 21 side of the second rack bar accommodation portion 220. Then, the first transmission mechanism accommodation portion 212 is joined with the second transmission mechanism accommodation portion 221, and a transmission mechanism accommodation part 90 accommodating the transmission mechanism 9 between the first transmission mechanism accommodation portion 212 and the second transmission mechanism accommodation portion 221 is formed.

In addition, a motor unit MU configured integrally with the electric motor 7 and the control device 8 is attached to the outer part of the second transmission mechanism accommodation portion 221. The after-mentioned motor housing 70 is fastened together with the first housing 21 and the second housing 22 through a plurality of bolts 10, and the motor unit MU is fixed to the rack housing 2.

The transmission mechanism 9 includes an input-side pulley 91 that is a motor-side pulley, an output-side pulley 92 that is a nut-side pulley, a belt 93 that is a power transmission member wound between the both pulleys 91 and 92, and the ball screw 94 serving as a deceleration mechanism for converting the rotation of the output-side pulley 92 to the axial movement of the rack bar 4 while decelerating the rotation of the output-side pulley 92. The input-side pulley 91 includes an input-side winding portion 911 as a second winding portion formed in a cylindrical shape having a relatively smaller diameter than the output-side pulley 92, and is press-fitted to the outer peripheral side at the distal end of an output shaft 713 of the electric motor 7, through a through hole 912 penetratingly formed on the inner peripheral side of the input-side pulley 91. That is, the input-side pulley 91 rotates integrally with the output shaft 713 around a second reference axis A2 corresponding to the rotation axis of the output shaft 713 of the electric motor 7. The output-side pulley 92 is disposed on the outer peripheral side of the rack bar 4, and is linked with the rack bar 4 through the ball screw 94. Specifically, the output-side pulley 92 includes a output-side winding portion 921 as a first winding portion formed in a cylindrical shape with a bottom having a relatively larger diameter than the input-side pulley 91, and is fixed to a facing end surface of the after-mentioned nut 941 received in a recessed portion 922 formed on the inner peripheral side of the output-side pulley 92 by a plurality of bolts 14. With this, the output-side pulley 92 rotates integrally with the after-mentioned nut 941 around a first reference axis A1 corresponding to the central axis of the rack bar 4. The belt 93 is an endless V-shaped belt in which, as core materials, glass fibers and copper wires are buried, and transmits the rotation force of the input-side pulley 91 to the output-side pulley 92 by synchronously rotating the input-side pulley 91 and the output-side pulley 92.

The electric motor 7 is a surface magnet type synchronous motor of a so-called three-phase AC type, and a motor element 71 is accommodated in the cylindrical motor housing 70 having a bottom. The one end side in the axial direction of the motor housing 70 which faces the second transmission mechanism accommodation potion 221 is closed. On the other hand, the other end side thereof is formed to be opened, and through this opening, the motor element 71 is connected to the control device 8. In addition, the one end side of the motor housing 70 is formed in a convex shape, and is configured to be cable of being centered to a motor engagement hole of the second transmission mechanism accommodation portion 221, so as to be a so-called in-low (socket-spigot) relationship.

The motor element 71 includes a cylindrical stator 711 fixed to the inner peripheral surface of the motor housing 70 by shrinkage fitting, a cylindrical rotor 712 disposed on the inner peripheral side of the stator 711 through a predetermined redial clearance, and the output shaft 713 which is fixed to the inner peripheral side of the rotor 712 so as to be integrally rotatable and which outputs the rotation of the rotor 712. The distal end side of the output shaft 713 (transmission mechanism 9 side) faces the inside of the transmission mechanism accommodation part 90 through a through hole formed to one end wall of the motor housing 70, and is connected to the transmission mechanism 9 (input-side pulley 91). In addition, a motor rotation angle sensor 72 for detecting the rotation angle of the output shaft 713 is provided to a base end side of the output shaft 713 (control device 8 side). That is, by feedback of the detection result of the motor rotation angle sensor 72 to the control device 8, the electric motor 7 is driven and controlled by the control device 8.

In the control device 8, a control board 81 on which electronic parts such as a microcomputer and the like for controlling energization to the electric motor 7 are mounted is accommodated in a substantially rectangular cylindrical control housing 80, and is provided so as to close the opening on the other end side of the motor housing 70. The control board 81 is connected to the electric motor 7 and the motor rotation angle sensor 72 by wire connection between the control housing 80 and the motor housing 70 communicating with each other, and the control device 8 drives and controls the electric motor 7 in accordance with a steering torque, a vehicle speed and the like based on the detection result of the motor rotation angle sensor 72. The control housing 80 is configured of a cylindrical body 801 and a cover 802, and one end side thereof (left side in FIG. 2) is formed by the body 801 covered to the outer peripheral side of the other end portion of the motor housing 70 and the cover 802 closes the other end side of the body 801.

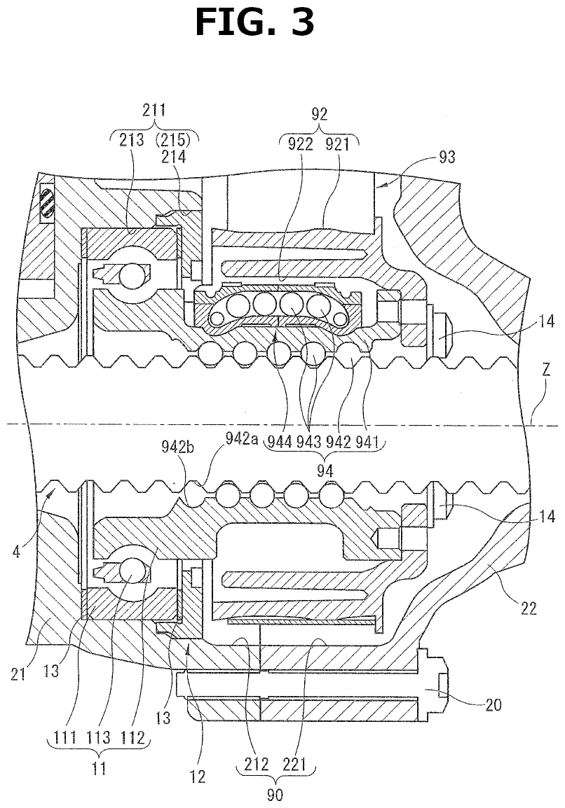

FIG. 3 is a main part enlarged view of FIG. 2 which shows a vicinity of the enlarged ball screw 94 in FIG. 2.

As shown in FIG. 3, the deceleration mechanism accommodation part 211 includes an outer race accommodation portion 213 accommodating an outer race 111 of the after-mentioned ball bearing 11, and a lock nut accommodation portion 214 formed in a step shape such that the diameter thereof is enlarged with respect to the outer race accommodation portion 213 and accommodating the after-mentioned lock nut 12 for fixing of the outer race 111.

The ball screw 94 includes a cylindrical nut 941 disposed on the outer peripheral side of the rack bar 4, a ball circulation groove 942 formed between the nut 941 and the rack bar 4, a plurality of balls 943 as rolling elements which are rollably provided in the ball circulation groove 942, and a tube 944 serving as a circulation mechanism for the circulation of the balls 943 by connecting the both ends of the ball circulation groove 942. The nut 941 is formed in a cylindrical shape surrounding the rack bar 4, and is provided to be rotatable relative to the rack bar 4. The ball circulation groove 942 is configured of a shaft-side ball screw groove 942a as a turning shaft-side ball screw groove having a helical groove shape which is provided on the outer peripheral side of the rack bar 4, and of a nut-side ball screw groove 942b having a helical groove shape which is provided on the inner peripheral side of the nut 941.

The nut 941 is rotatably supported through the ball bearing 11 accommodated in the deceleration mechanism accommodation part 211 (outer race accommodation portion 213). The ball bearing 11 is attached and fixed to the outer race accommodation portion 213 by the lock nut 12 serving as a fixing member accommodated in the lock nut accommodation portion 214. Specifically, the ball bearing 11 is configured of the outer race 111 fixed to the outer race accommodation portion 213 by the lock nut 12, an inner race 112 disposed to face the inner peripheral side of the outer race 111 and formed integrally with the nut 941, and of a plurality of balls 113 rollably accommodated between the outer race 111 and the inner race 112. In addition, in the present embodiment, as an example, although one in which the inner race 112 is formed integrally with the nut 941 is shown, the inner race 112 is not limited to one formed integrally with the nut 941. That is, the inner race 112 may be formed separately from the nut 914, and then is fixed to the nut 941.

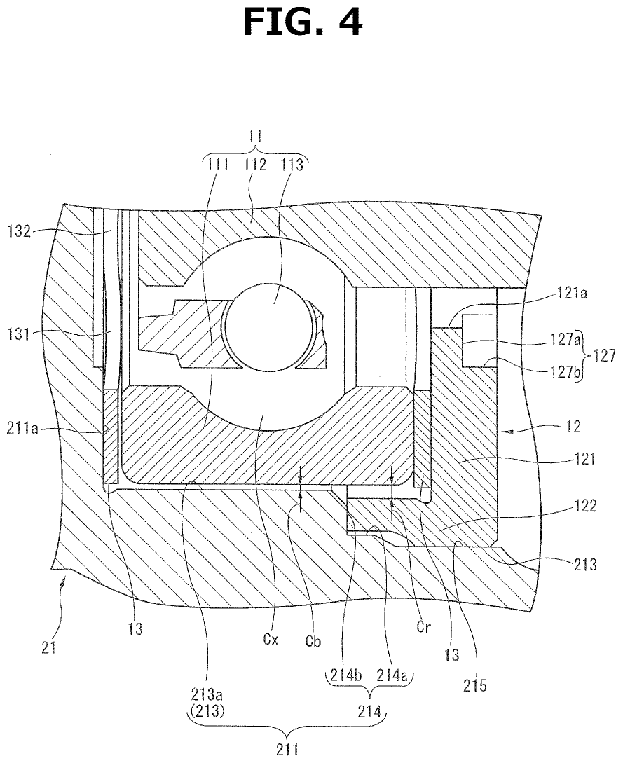

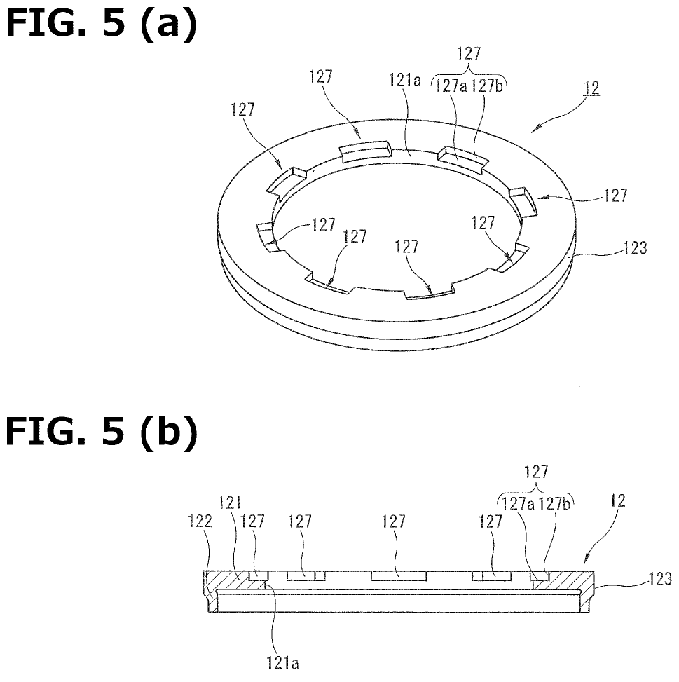

FIG. 4 is a main part enlarged view of FIG. 3 which shows a vicinity of the ball bearing 11 of FIG. 3. FIG. 5 is a drawing showing the lock nut 12 as a single body, and FIG. 5(a) shows a perspective view of the lock nut 12 and FIG. 5(b) shows a longitudinal sectional view of the lock nut 12. In addition, in the explanation in each of FIG. 4 and FIG. 5, the direction parallel to a rotation axis Z of the nut 941 is referred to as “axial direction”, the direction orthogonal to the rotation axis Z of the nut 941 is referred to as “radial direction”, and the direction around the rotation axis Z of the nut 941 is referred to as “circumferential direction”.

As shown in FIG. 4, the outer race accommodation portion 213 includes an outer race facing surface 213a that is an outer race radial facing surface facing the outer race 111 of the ball bearing 11 in the radial direction, and is set to have an inner diameter capable of allowing press-fitting of the outer race 111. The lock nut accommodation portion 214 includes a lock nut facing surface 214a that is a fixing member radial facing surface facing the lock nut 12 in the radial direction, and an axial direction regulating portion 214b which faces the distal end surface of the lock nut 12 in the axial direction (the distal end surface of a fixing portion 122) and which regulates the movement in the axial direction of the lock nut 12 by abutting. In addition, regarding the lock nut facing surface 214a, the inner diameter thereof is set such that a clearance Cr between the fixing portion 122 of the lock nut 12 and the lock nut facing surface 214a becomes larger than a clearance Cb between the outer peripheral surface of the outer race 111 and the outer race facing surface 213a.

The lock nut 12 is formed in a substantially cylindrical shape having a bottom by forging metal material, such as aluminum alloy material. Specifically, the lock nut 12 integrally includes a facing portion 121 facing an end surface of a pair of the axial end surfaces of the outer race 111 of the ball bearing 11, the one end surface which is located on the output-side pulley 92 side, and the fixing portion 122 fixing the facing portion 121 to the deceleration mechanism accommodation part 211. That is, the lack nut 12 is fixed to the deceleration mechanism accommodation part 211 through the fixing portion 122, and the outer race 111 is fixed so as to be sandwiched between the facing portion 121 and the step portion 211a. In addition, at this time, a wave washer 13 that is a washer having a wave shape is interposed in each of the spaces between the outer race 111 and the facing portion 121 and between the outer race 111 and the step portion 211a, and by the urging forces of the wave washers 13, the lock nut 12 is suppressed from being loosened.

As shown in FIG. 5, the facing portion 121 has a flat disc shape having a substantially constant thickness, and a circular through hole 121a through which the nut 941 passes is penetratingly formed at the middle position of the lock nut 12. The through hole 121a is set to have an inner diameter slightly larger than the outer diameter of the nut 941, and a plurality of tool engagement grooves 127 engaging with a fastening tool 15 at the time of the fastening of the lock nut 12 are cut out and formed at the hole edge on the output-side pulley 92 of the through hole 121a. Each of the tool engagement grooves 127 is a concave portion opened toward the output-side pulley 92 in the axial direction, has a substantially rectangular shape in a plane view, and includes a bottom wall 127a facing the ball bearing 11 and an engagement surface 127b, and a pair of engagement surfaces 127b, 127b face each other in the circumferential direction and are arranged parallel to each other. That is, rotation force of the fastening tool 15 engaging with each of the tool engagement grooves 127 is transmitted to the lock nut 12, through engagement surfaces 127b, 127b. In addition, as shown in FIG. 4, the bottom wall 127a of each of the tool engagement grooves 127 faces a radial clearance Cx between the outer race 111 and the inner race 112 in the axial direction, thereby functioning as a partition wall for suppressing the leakage of lubricant (grease) applied to the inside of the clearance Cx.

The fixing portion 122 has a substantially cylindrical shape extending toward the ball bearing 11 at the radial outer side of the facing portion 121, and is formed with, at the outer peripheral side thereof, a male screw portion 123 screwed with the female screw portion 215 formed at the end portion on the second housing 22 side of the deceleration mechanism accommodation part 211. The male screw portion 123 is formed to extend from the radial outer side of the facing portion 121 to the ball bearing 11 side so as to be overlapped with the facing portion 121 in the axial direction. Here, in the present embodiment, the male portion 123 is formed so as to be overlapped with the outer race 111 in the axial direction, and is provided so as to extend from the radial outer side of the facing portion 121 to the outer peripheral area of the outer race 111.

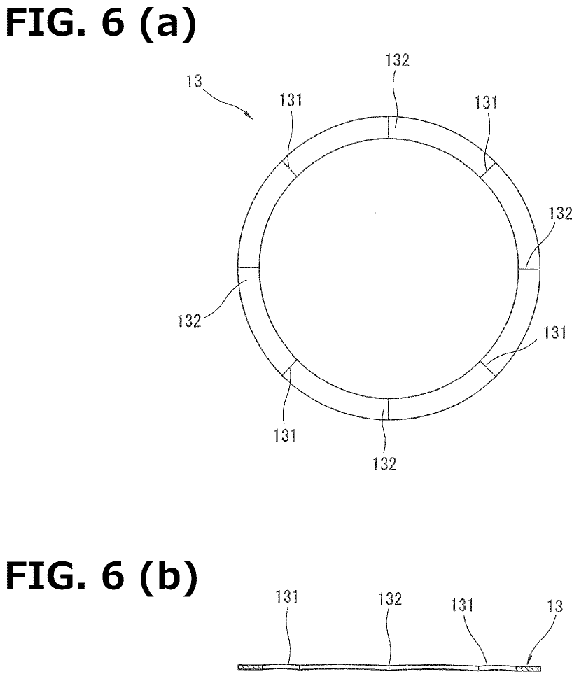

FIG. 6 is a drawing showing the wave washer 13 as a single body, and FIG. 6(a) is a plane view of the wave washer 13 and FIG. 6(b) is a longitudinal sectional view of the wave washer 13.

As shown in FIG. 6, the wave washer 13 is formed in a substantially annular shape by press-forming a material of a plate-like magnetic body. Specifically, the wave washer 13 is a wall-known washer having a wave shape, and has an annular shape having a constant radial width along the circumferential direction. In the wave washer 13, convex portions 131 projecting in the axial direction and concave portions 132 recessed in the axial direction are alternately arranged in the circumferential direction. With this, the wave washer 13 is sandwiched in each of the spaces between the facing portion 121 of the lock nut 12 and the outer race 111 of the ball bearing 11 and between the step portion 211a of the deceleration mechanism accommodation part 211 and the outer race 111 of the ball bearing 11 (see FIG. 4), and the convex portions 131 are crashed and deformed (elastic deformation), and with a restoring force generated by this deformation, the lock nut 12 is suppressed from being loosened.

### Method for Manufacturing Power Steering Apparatus

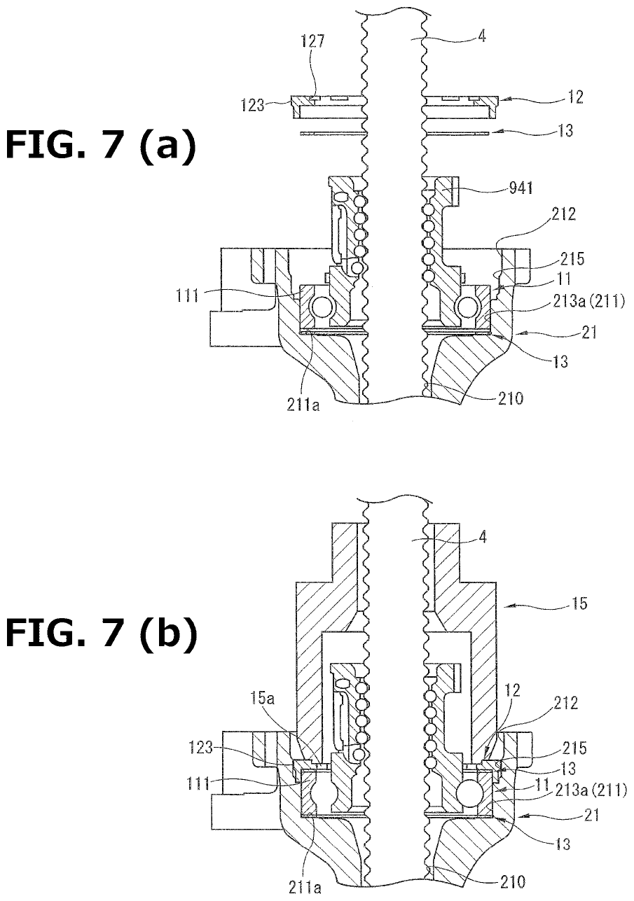

FIG. 7 is a drawing showing a fixing method of the ball bearing 11, and FIG. 7(a) is a sectional view showing a state in which the ball bearing 11 is inserted into the deceleration mechanism accommodation part 211 of the first housing 21 and FIG. 7(b) is a sectional view showing a state in which the ball bearing 11 is fixed by screwing the lock nut 12 through the fastening tool 15.

First, as shown in FIG. 7(a), the first housing 21 is arranged such that the first transmission mechanism accommodation portion 212 is located vertically upward, and the wave washer 13 is mounted on the step portion 211a of the deceleration mechanism accommodation part 211. After that, the nut 941 and the ball bearing 11 which had been integrated with (assembled with) the rack bar 4 in advance are inserted into the deceleration mechanism accommodation part 211 from the first transmission mechanism accommodation portion 212 side. Specifically, the one end side of the outer race 111 of the ball bearing 11 integrated with the rack bar 4 is press-fitted to the outer race facing surface 213a of the deceleration mechanism accommodation part 211, while the one end side of the rack bar 4 is inserted into the first rack bar accommodation portion 210.

Next, as shown in FIG. 7(b), the wave washer 13 is mounted on the end surface on the other end side of the outer race 111 press-fitted to the deceleration mechanism accommodation part 211 so as to be superposed thereon, following which the male screw portion 123 of the lock nut 12 is screwed to the female screw portion 215 of the deceleration mechanism accommodation part 211 from the distal end side. After that, the substantially cylindrical fastening tool 15 having a plurality of distal end engagement portions 15a corresponding to the respective tool engagement grooves 127 is inserted to the tool engagement grooves 127 of the lock nut 12 from the outer end side of the facing portion 121 by allowing the rack bar 4 to pass through the inner peripheral side of the fastening tool 15. Then, the distal end engagement portions 15a of the fastening tool 15 are engaged with corresponding ones of the tool engagement grooves 127, and by turning the fastening tool 15 clockwise, the outer race 111 is fixed between the facing portion 121 of the lock nut 12 and the step portion 211a of the deceleration mechanism accommodation part 211 so as to be sandwiched therebetween. With this, the assembling of the ball bearing 11 to the first housing 21 is completed.

### Working Effect of The Present Invention

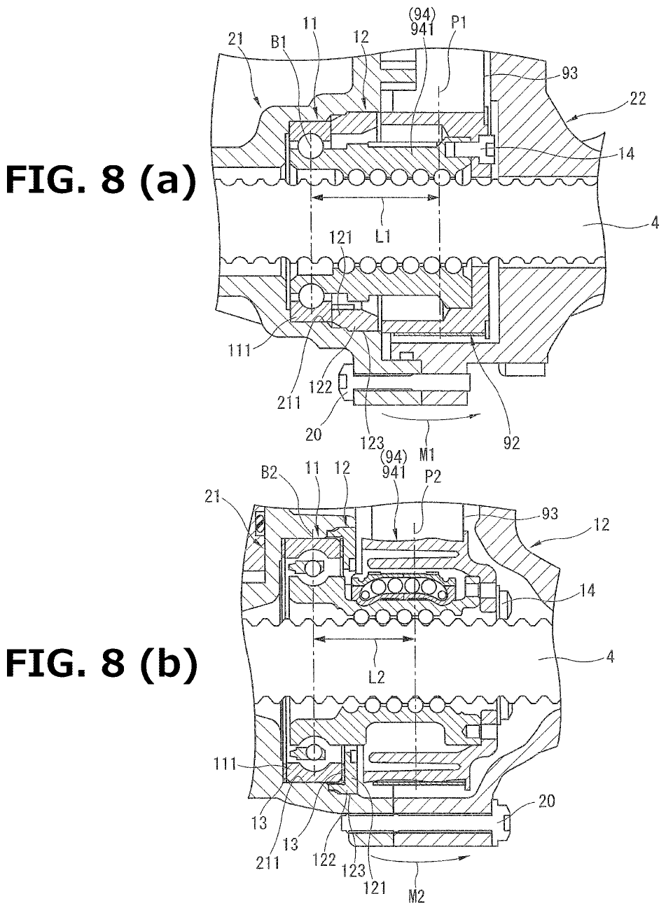

FIG. 8 is a drawing in which a conventional power steering apparatus and the above-mentioned power steering apparatus 1a are compared with each other, and FIG. 8(a) is an enlarged sectional view near a ball screw of the conventional power steering apparatus and FIG. 8(b) is an enlarged sectional view near the ball screw 94 of the power steering apparatus 1a.

That is, as shown in FIG. 8(a), in a lock nut 12 of the conventional power steering apparatus, a fixing portion 122 having a male screw portion 123 on the outer peripheral side thereof is provided so as to extend toward an output-side pulley 92 with respect to a facing portion facing an outer race 111. Consequently, a distance L1 between a ball bearing 11 and the output-side pulley 92, that is, a distance L1 between an axial center point B1 of the ball bearing 11 that is a fulcrum and an axial center point P1 of the output-side pulley 92 that is a point of application of the tension of a belt becomes relatively long. Therefore, in case of the configuration of the conventional power steering apparatus in which a nut 941 shown in FIG. 8(a) is in a cantilever-supported state, there is a problem that due to the tension of the belt 93, a moment M1 that acts on the ball bearing 11 increases, and friction in the ball bearing 11 increases.

In contrast to this, in the power steering apparatus 1a according to the present embodiment, the following effects can be achieved, and thereby the problem of the conventional power steering apparatus can be solved.

That is, the power steering apparatus 1a includes: the rack housing 2 that is a housing having the first and second rack bar accommodation portions 210 and 220 that are a turning shaft accommodation part, and a deceleration mechanism accommodation part 211; the rack bar 4 as a turning shaft 4 which is provided in the housing 2 and which turns the turning wheels by an axial movement accompanying the rotation of the steering wheel; the shaft-side ball screw groove 942a as a turning shaft-side ball screw groove having a helical groove shape, and provided on the outer peripheral side of rack bar 4; the nut 941 provided annularly so as to surround the rack bar 4 in the deceleration mechanism accommodation part 211 of the rack housing 2; the nut-side ball screw groove 942b provided on the inner peripheral side of the nut 941, having a helical groove shape, and configuring the ball circulation groove 942 together with the shaft-side ball screw groove 942a; a plurality of the balls 943 disposed inside the ball circulation groove 942; the tube 944 serving as a circulation mechanism for circulating a plurality of the balls 943 from one end side to the other end side of the ball circulation groove 942; the output-side pulley 92 as a nut-side pulley provided to the nut 941, and having the output-side winding portion 921 as a first winding portion that is a cylindrical portion surrounding a part of the nut 941 in the direction of the rotation axis Z of the nut 941; the electric motor 7 having the output shaft 713; the input-side pulley 91 as a motor-side pulley having the cylindrical input-side winding portion 911 as a second winding portion, and provided to the output shaft 713 of the electric motor 7; the belt 93 as a power transmission member wound between the output-side winding portion 921 and the input-side winding portion 911; the ball bearing 11 that is a ball bearing disposed more on one side than the output-side winding portion 921 in the direction of the rotation axis Z of the nut 941, and which has the inner race 112 provided to the nut 941, the outer race 111 disposed on the outer side of the inner race 112 in the radial direction relative to the rotation axis Z of the nut 941, and a plurality of the balls 113 disposed between the inner race 112 and the outer race 111; and the lock nut 12 serving as a fixing member that is a fixing member for fixing the outer race 111 to the rack housing 2, and which is provided with the facing portion 121 facing an end surface of a pair of end surfaces of the outer race 111 in the direction of the rotation axis Z of the nut 941, the end surface which is located on the output-side winding portion 921 side, and the fixing portion 122 for fixing the facing portion 121 to the rack housing 2, wherein the fixing portion 122 has a portion overlapped with the facing portion 121 in the direction of the rotation axis Z of the nut 941, and is disposed on the outer side of the facing portion 121 in the radial direction relative to the rotation axis Z of the nut 941.

As shown in FIG. 8(b), in the present embodiment, the fixing portion 122 of the lock nut 12 is disposed on the radial outer side of the facing portion 121, and thereby the projection amount of the lock nut 12 toward the output-side pulley 92 side is suppressed. Accordingly, the output-side pulley 92 and the belt 93 can be arranged closer to the ball bearing 11 side, and the arm length of a moment M2 based on a distance L2 between an axial center point B2 of the ball bearing 11 and an axial center point P2 of the output-side pulley 92 (belt 93) can be reduced. With this, the moment M2 based on the arm length can be reduced, and friction in the ball bearing 11 can be reduced. Consequently, steering feeling can be improved and power transmission loss can be reduced.

In addition, in the present embodiment, the fixing portion 122 of the lock nut 12 includes a portion overlapped with the outer race 111, in the direction of the rotation axis Z of the nut 942.

In this way, the fixing portion 122 is extended toward the outer race 111 side that is the opposite side to the output-side pulley 92 so as to be overlapped with the outer race 111, and thereby the fixing allowance of the fixing portion 122 can be enlarged, while suppressing the projection amount of the lock nut 12 toward the output-side pulley 92.

In addition, in the present embodiment, the lock nut 12 is formed in an annular shape, the fixing portion 122 of the lock nut 12 includes the male screw portion 123 provided on the outer peripheral side of the portion overlapped with the outer race 111, in the radial direction relative to the rotation axis Z of the nut 941, and the rack housing 2 includes the female screw portion 215 which is screwed with the male screw portion 123.

In this way, the male screw portion 123 is provided at a part in the fixing portion 122 which overlaps with the outer race 111, and thereby the projection amount of the lock nut 12 toward the output-side pulley 92 side can be suppressed, while sufficiently ensuring the engagement allowance of the male screw portion 123. In other words, the male portion 123 is overlapped with the outer peripheral side of the outer race 111, thereby reducing the axial dimension of the facing portion 121 by the engagement allowance of the male portion 123 obtained by the overlapping, and consequently, the projection amount of the lock nut 12 toward the output-side pulley 92 can be further effectively suppressed.

In addition, in the present embodiment, the lock nut 12 includes the tool engagement grooves 127 that are tool engagement grooves provided on the inner side of the lock nut 12 in the radial direction relative to the rotation axis Z of the nut 941, and which engage with the fastening tool 15 at the time when the male screw portion 123 of the lock nut 12 is screwed to the female screw portion 215 of the rack housing 2.

In this way, the tool engagement grooves 127 are provided on the inner peripheral side of the lock nut 12, and thereby an increase in the radial dimension of the lock nut 12 can be suppressed.

In addition, in the present embodiment, the lock nut 12 includes the bottom walls 127a serving as a partition wall for suppressing leakage of lubricant applied to the ball bearing 11, the bottom walls 127a which are provided between the tool engagement grooves 127 and the ball bearing 11 in the direction of the rotation axis Z of the nut 941.

In this way, the bottom walls 127a are interposed between the tool engagement grooves 127 and the ball bearing 11, and thereby leakage of grease as lubricant of the ball bearing 11 toward a power transmission member, such as the belt 93, can be suppressed by the bottom walls 127a.

In addition, in the present embodiment, the tool engagement grooves 127 are concave portions opened toward the output-side pulley 92 in the direction of the rotation axis Z of the nut 941.

In this way, the tool engagement grooves 127 are formed as concave portions opened toward the output-side pulley 92, and thereby fastening work of the lock nut 12 can be carried out by simply inserting and engaging the fastening tool 15 into and with the concave portions. In addition, by the bottom wall 127a of the concave portion of each of the tool engagement grooves 127 which is formed to have a bottom, leakage of lubricant applied to the ball bearing 11 can be suppressed.

In addition, in the present embodiment, in the radial direction relative to the rotation axis Z of the nut 941, the rack housing 2 is provided with the outer race facing surface 213a that is an outer race radial facing surface facing the outer race 111, and the lock nut facing surface 214a that is a fixing member radial facing surface facing the fixing member 12, and, in the radial direction, the clearance Cr between the outer peripheral surface of the lock nut 12 and the lock nut facing surface 214a is larger than the clearance Cb between the outer peripheral surface of the outer race 111 and the outer race facing surface 213a.

In this way, the clearance Cr on the lock nut facing surface 214a side is set larger than the clearance Cb on the outer race facing surface 213a side, and priority is given to the positioning in the radial direction of the outer race 111 over that of the lock nut 12, and thereby the supporting accuracy of the nut 941 can be improved. In addition, by this configuration, even in a case where machining errors and assembling errors occur, the interference between the lock nut 12 and the outer race 111 can be suppressed.

In addition, in the present embodiment, the power steering apparatus 1a includes the annular wave washer 13 for urging the outer race 111 in the direction of the rotation axis Z of the nut 941, the wave washer 13 which is provided between the facing portion 121 of the fixing member 12 and the outer race 111 in the direction of the rotation axis Z of the nut 941, and the wave washer 13 is formed with the convex portions 131 projecting and the concave portions 132 recessed in the direction of the rotation axis Z of the nut 941 which are alternately arranged around the rotation axis Z of the nut 941.

In this way, the wave washer 13 is interposed between the facing portion 121 of the lock nut 12 and the outer race 111, and thereby, by this wave washer 13, it becomes possible to urge the outer race 111 in the axial direction. Consequently, shakiness of the outer race 111 can be suppressed. In addition, by the elastic effect of the wave washer 13, the impact between the rack housing 2 and the nut 941 can be buffered. With this, abnormal sound generated from the power steering apparatus 1a can be also suppressed.

In addition, in the present embodiment, the rack housing 2 includes the axial direction regulating portion 214b which faces an end surface of the lock nut 12 in the direction of the rotation axis Z of the nut 941.

In this way, since the axial direction regulating portion 214b facing the end surface of the lock nut 12 in the axial direction is provided to the deceleration mechanism accommodation part 211 of the rack housing 2 (first housing 21), by this axial direction regulating portion 214b, the axial position of the lock nut 12 can be regulated. With this, the dimension accuracy of the axial clearance between the facing portion 121 of the lock nut 12 and the outer race 111 can be improved. Consequently, variation of the set load of the wave washer 13 on every product of the power steering apparatus 1a can be suppressed.

### Second Embodiment

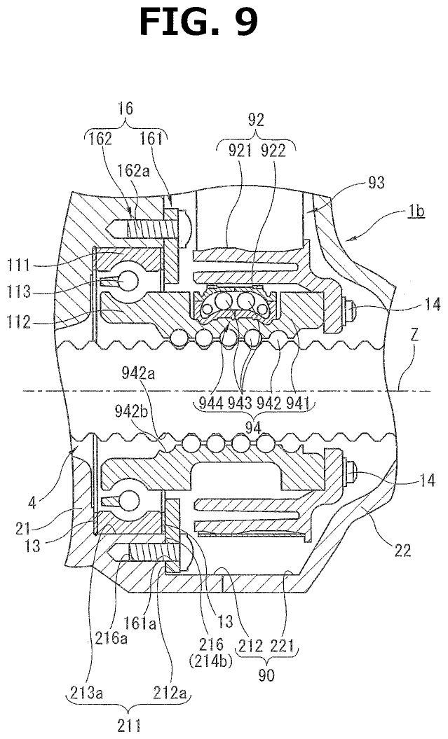

FIG. 9 shows a second embodiment of the power steering apparatus according to the present invention. In addition, the present embodiment is one in which a fixing means of the outer race 111 of the ball bearing 11 has been changed, with respect to the first embodiment, and other configurations are the same as the first embodiment. Therefore, the same symbols are applied to the same components, and redundant explanation is omitted.

FIG. 9 shows an enlarged sectional view showing a vicinity of a ball screw 94 according to the second embodiment of the present invention. In addition, in the explanation of the present drawing, the direction parallel to a rotation axis Z of a nut 941 is referred to as “axial direction”, the direction orthogonal to the rotation axis Z of the nut 941 is referred to as “radial direction”, and the direction around the rotation axis Z of the nut 941 is referred to as “circumferential direction”.

As shown in FIG. 9, in a power steering apparatus 1b according to the present embodiment, a fixing member 16 fixing the outer race 111 is configured of a plate-like member 161 disposed facing the end surface on an output-side pulley 92 side of the outer race 111, and of screws 162 fixing the plate-like member 161 to a first housing 21. Then, by a part of the plate-like member 161 which faces the outer race 111, a facing part of the present invention is configured. In addition, by a part of the plate-like member 161 that is a region extending to the outer peripheral side of the facing part and which faces the after-mentioned surface 216 to be fixed and by a plurality of the screws 162 fastening the part facing the fixing surface 216 to the fixing surface 216, a fixing part of the present invention is configured.

In the present embodiment, a deceleration mechanism accommodation part 211 of the first housing 21 is formed in a step shape whose diameter is enlarged stepwise toward a first transmission mechanism accommodation portion 212. That is, the deceleration mechanism accommodation part 211 includes an outer race facing surface 213a facing the outer peripheral surface of the outer race 111, and a plate-like member facing surface 212a that is a s fixing member radial facing surface which faces the plate-like member 161, and which is formed in a step shape whose diameter is enlarged with respect to the outer race facing surface 213a. In addition, the deceleration mechanism accommodation part 211 includes an end surface parallel to the radial direction between the outer race facing surface 213a and the plate-like member facing surface 212a, and the fixing surface 216 for the fixing of the plate-like member 161 by the screws 162 is formed thereto. In addition, the fixing surface 216 also functions as the above-mentioned axial direction regulating portion 214b regulating the axial movement of the plate-like member 161. Moreover, this fixing surface 216 is formed with female screw holes 216a to which the respect screws 162 are screwed, at positions corresponding to a plurality of the after-mentioned through holes 161a of the plate-like member 161.

The plate-like member 161 has a disc shape having a substantially constant thickness and is set to have an outer diameter slightly smaller than the inner diameter of the plate-like member facing surface 212a, and an outer peripheral side of the plate-like member 161 is formed so as to face the fixing surface 216. Then, a plurality of the through holes 161a through which the respective screws 162 pass are penetratingly formed to the outer peripheral side of the plate-like member 161 facing the fixing surface 216, at substantially equal intervals along the circumferential direction.

Each of the screws 162 is a well-known round head screw, and is provided on the radial outer side of the plate-like member 161 so as to be overlapped with the plate-like member 161 in the axial direction. A male screw portion 162a formed on the distal end side of each of the screws 162 is screwed from the output-side pulley 92 side to a corresponding one of the female screw holes 216a of the fixing surface 261 in a state in which the screws 162 pass through the respective through holes 161a of the plate-like member 161, and the plate-like member 161 is fastened to the fixing surface 216 by the screws 162. With this, also in the present embodiment, the male screw portions 162a of the screws 162 configuring the fixing part of the present invention is configured so as to overlap with the outer race 111 in the axial direction.

As the above, in the present embodiment, the fixing part is the screw 162 having the male screw portion 162a overlapped with the outer race 111 in the rotation axis Z of the nut 941.

In this way, since the fixing part of the fixing member 16 is configured by the screw 162, as compared with a case where a fixing member having a lock nut shape, such as the lock nut 12 according to the first embodiment, is fixed to the rack housing 2 (deceleration mechanism accommodation part 211 of the first housing 21), it is possible to relatively easily carry out fixing work of the fixing member 16.

In other words, since the outer diameter and the screw pitch of the lock nut 12 are larger than those of the screw 162, so-called scuffing (galling, scoring) tends to occur at the time of fastening work. In contrast to this, the outer diameter and the screw pitch of the screw 162 are smaller, and fastening work can be easily carried out, and consequently, assembling workability of the power steering apparatus 1b can be improved.

### Third Embodiment

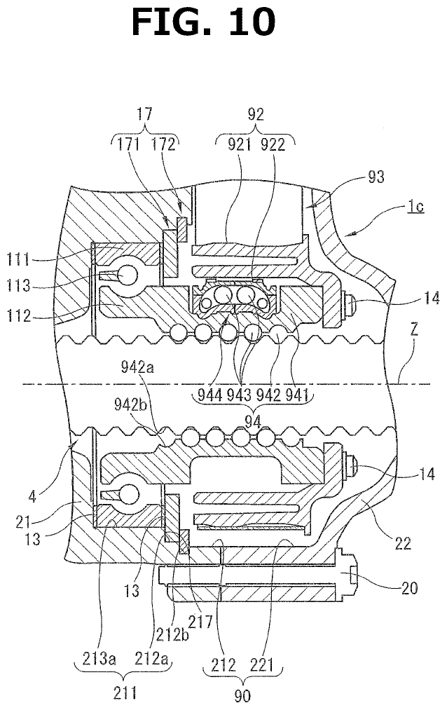

FIG. 10 shows a third embodiment of the power steering apparatus according to the present invention. In addition, the present embodiment is one in which a fixing means of the outer race 111 of the ball bearing 11 has been changed, with respect to the first embodiment, and other configurations are the same as the first embodiment. Therefore, the same symbols are applied to the same components, and redundant explanation is omitted.

FIG. 10 shows an enlarged sectional view showing a vicinity of a ball screw 94 according to the third embodiment of the present invention. In addition, in the explanation of the present drawing, the direction parallel to a rotation axis Z of a nut 941 is referred to as “axial direction”, the direction orthogonal to the rotation axis Z of the nut 941 is referred to as “radial direction”, and the direction around the rotation axis Z of the nut 941 is referred to as “circumferential direction”.

As shown in FIG. 10, in a power steering apparatus 1c according to the present embodiment, a fixing member 17 fixing an outer race 111 is configured of a plate-like member 171 disposed facing the end surface on an output-side pulley 92 side of the outer race 111, and of a circlip 172 regulating the position of the plate-like member 171 with respect to a first housing 21. Then, by a part of the plate-like member 171 which faces the outer race 111, a facing part of the present invention is configured. In addition, by a part of the plate-like member 171 that is a plate-like part extending to the outer peripheral side of the above facing part, and which faces the after-mentioned regulating surface 217 and is sandwiched between the regulating surface 217 and the circlip 172, a fixing part of the present invention is configured.

In the present embodiment, a deceleration mechanism accommodation part 211 is formed in a step shape whose diameter is enlarged stepwise toward a first transmission mechanism accommodation portion 212. That is, the deceleration mechanism accommodation part 211 includes an outer race facing surface 213a facing the outer peripheral surface of the outer race 111, and a plate-like member facing surface 212a that is a surface radially facing the fixing member which faces the plate-like member 171, and which is formed in a step shape whose diameter is enlarged with respect to the outer race facing surface 213a. In addition, the regulating surface 217 which has an end surface parallel to the radial direction and used for regulating the position of the plate-like member 171 by the circlip 172 is formed between the outer race facing surface 213a and the plate-like member facing surface 212a. Moreover, the plate-like member facing surface 212a is formed with a circular arc circlip engagement groove 212b extending in the circumferential direction with which the circlip 172 engages to be held so as to be able to come in contact with the plate-like member 171.

The plate-like member 171 has a disc shape having a substantially constant thickness and is set to have an outer diameter slightly smaller than the inner diameter of the plate-like member facing surface 212a, and an outer peripheral side of the plate-like member 171 is formed so as to face the regulating surface 217.

The circlip 172 is a well-known circlip, and is inserted from an outer-side pulley 92 side in a state of being reduced in diameter by pressing it from the outer side thereof so as to be narrowed toward a radially inner side, and then the pressing is released at the time when the circlip 172 comes in contact with the plate-like member 171 and the circlip 712 returns, and consequently, it engages with the circlip engagement groove 212b. With this, the plate-like member 171 is sandwiched between the circlip 172 and the regulating surface 217, and the movement in the axial direction of the plate-like member 171 is regulated.

As the above, the power steering apparatus 1c according to the present embodiment is provided with the circlip 172 for regulating the position of the plate-like member 171 (the above-mentioned fixing portion) with respect to the rack housing 2 in the direction of the rotation axis Z of the nut 941, the fixing portion is a plate-like portion extending to an outer side of the facing portion in the radial direction relative to the rotation axis Z of the nut 941, the rack housing 2 is provided with the circular arc circlip engagement groove 212b provided on the inner peripheral side of the rack housing 2, and extending in the direction around the rotation axis Z of the nut 941, and the circlip 172 engages with the circlip engagement groove 212b, and is disposed so as to come in contact with the plate-like portion.

In this way, by the circlip 172, the regulation for the position in the axial direction of the fixing part is carried out, and consequently, it becomes not necessary to screw a fixing member, like the first and second embodiments in which the lock nut 12 or the screw 162 is used as a fixing member. That is, since the position regulation in the axial direction of the fixing part is completed by simply inserting the circlip 172, assembling workability of the power steering apparatus 1c can be further improved.

The present invention is not limited to the configurations in the embodiments, and if it is a mode which is capable of obtaining the working effects of the present invention, it can be freely modified in accordance with specifications of a steering apparatus to which the present invention is applied.

As a power steering apparatus based on the embodiments explained above, for example, the following aspects can be considered.

That is, the power steering apparatus, in one aspect thereof, includes: a housing including a turning shaft accommodation part and a deceleration mechanism accommodation part; a turning shaft which is provided in the housing, and which turns turning wheels by an axial movement accompanying a rotation of a steering wheel; a turning shaft-side ball screw groove having a helical groove shape, and provided on an outer peripheral side of the turning shaft; a nut provided annularly so as to surround the turning shaft in the deceleration mechanism accommodation part of the housing; a nut-side ball screw groove provided on an inner peripheral side of the nut, having a helical groove shape, and configuring a ball circulation groove together with the turning shaft-side ball screw groove; a plurality of balls disposed inside the ball circulation groove; a circulation mechanism for circulating a plurality of the balls from one end side to the other end side of the ball circulation groove; a nut-side pulley provided to the nut, and including a first winding portion that is a cylindrical portion surrounding a part of the nut in a direction of a rotation axis of the nut; an electric motor including an output shaft; a motor-side pulley including a cylindrical second winding portion, and provided to the output shaft of the electric motor; a power transmission member wound between the first winding portion and the second winding portion; a ball bearing that is a ball bearing disposed more on one side than the first winding portion in the direction of the rotation axis of the nut, and which includes an inner race provided to the nut, an outer race disposed on an outer side of the inner race in an radial direction relative to the rotation axis of the nut, and a plurality of balls disposed between the inner race and the outer race; and a fixing member that is a fixing member for fixing the outer race to the housing, and which is provided with a facing portion facing an end surface of a pair of end surfaces of the outer race in the direction of the rotation axis of the nut, the end surface which is located on a first winding portion side, and a fixing portion for fixing the facing portion to the housing, wherein the fixing portion includes a portion overlapped with the facing portion in the direction of the rotation axis of the nut, and is disposed on an outer side of the facing portion in the radial direction relative to the rotation axis of the nut.

In a preferable aspect of the power steering apparatus, the fixing portion of the fixing member includes a portion overlapped with the outer race, in the direction of the rotation axis of the nut.

In yet another preferable aspect, in any of the aspects of the power steering apparatus, the fixing member is formed in an annular shape, the fixing portion of the fixing member includes a male screw portion provided on an outer peripheral side of the portion overlapped with the outer race, in the radial direction relative to the rotation axis of the nut, and the housing includes a female screw portion which is screwed with the male screw portion.

In yet another preferable aspect, in any of the aspects of the power steering apparatus, the fixing member includes a tool engagement groove that is a tool engagement groove provided on an inner side of the fixing member in the radial direction relative to the rotation axis of the nut, and which engages with a fastening tool at a time when the male screw portion of the fixing member is screwed to the female screw portion of the housing.

In yet another preferable aspect, in any of the aspects of the power steering apparatus, the fixing member includes a partition wall for suppressing leakage of lubricant applied to the ball bearing, the partition wall which is provided between the tool engagement groove and the ball bearing in the direction of the rotation axis of the nut.

In yet another preferable aspect, in any of the aspects of the power steering apparatus, the tool engagement groove is a concave portion opened toward the nut-side pulley in the direction of the rotation axis of the nut.

In yet another preferable aspect, in any of the aspects of the power steering apparatus, the fixing portion is a screw including a male screw portion which overlaps with the outer race in the direction of the rotation axis of the nut.

In yet another preferable aspect, in any of the aspects of the power steering apparatus, in the radial direction relative to the rotation axis of the nut, the housing is provided with an outer race radial facing surface which faces the outer race, and a fixing member radial facing surface which faces the fixing member, and, in the radial direction, a clearance between an outer peripheral surface of the fixing member and the fixing member radial facing surface is larger than a clearance between an outer peripheral surface of the outer race and the outer race radial facing surface.

In yet another preferable aspect, in any of the aspects of the power steering apparatus, the power steering apparatus includes an annular wave washer for urging the outer race in the direction of the rotation axis of the nut, the wave washer which is provided between the facing portion of the fixing member and the outer race in the direction of the rotation axis of the nut, and the wave washer is formed with convex portions projecting and concave portions recessed in the direction of the rotation axis of the nut which are alternately arranged around the rotation axis of the nut.

In yet another preferable aspect, in any of the aspects of the power steering apparatus, the housing includes an axial direction regulating portion which faces an end surface of the fixing member in the direction of the rotation axis of the nut.

In yet another preferable aspect, in any of the aspects of the power steering apparatus, a circlip for regulating a position of the fixing portion with respect to the housing in the direction of the rotation axis of the nut is provided, the fixing portion is a plate-like portion extending to an outer side of the facing portion in the radial direction relative to the rotation axis of the nut, the housing is provided with a circular arc circlip engagement groove provided on an inner peripheral side of the housing, and extending in a direction around the rotation axis of the nut, and the circlip engages with the circlip engagement groove, and is disposed so as to come in contact with the plate-like portion.

1. A power steering apparatus comprising:
a housing including a turning shaft accommodation part and a deceleration mechanism accommodation part;
a turning shaft which is provided in the housing, and which turns turning wheels by an axial movement accompanying a rotation of a steering wheel;
a turning shaft-side ball screw groove having a helical groove shape, and provided on an outer peripheral side of the turning shaft;
a nut provided annularly so as to surround the turning shaft in the deceleration mechanism accommodation part of the housing;
a nut-side ball screw groove provided on an inner peripheral side of the nut, having a helical groove shape, and configuring a ball circulation groove together with the turning shaft-side ball screw groove;
a plurality of balls disposed inside the ball circulation groove;
a circulation mechanism for circulating a plurality of the balls from one end side to the other end side of the ball circulation groove;
a nut-side pulley provided to the nut, and including a first winding portion that is a cylindrical portion surrounding a part of the nut in a direction of a rotation axis of the nut;
an electric motor including an output shaft;
a motor-side pulley including a cylindrical second winding portion, and provided to the output shaft of the electric motor;
a power transmission member wound between the first winding portion and the second winding portion;
a ball bearing that is a ball bearing disposed more on one side than the first winding portion in the direction of the rotation axis of the nut, and which includes an inner race provided to the nut, an outer race disposed on an outer side of the inner race in an radial direction relative to the rotation axis of the nut, and a plurality of balls disposed between the inner race and the outer race; and
a fixing member that is a fixing member for fixing the outer race to the housing, and which is provided with a facing portion facing an end surface of a pair of end surfaces of the outer race in the direction of the rotation axis of the nut, the end surface which is located on a first winding portion side, and a fixing portion for fixing the facing portion to the housing, wherein the fixing portion includes a portion overlapped with the facing portion in the direction of the rotation axis of the nut, and is disposed on an outer side of the facing portion in the radial direction relative to the rotation axis of the nut.

2. The power steering apparatus according to claim 1, wherein the fixing portion of the fixing member includes a portion overlapped with the outer race, in the direction of the rotation axis of the nut.

3. The power steering apparatus according to claim 2, wherein the fixing member is formed in an annular shape,
wherein the fixing portion of the fixing member includes a male screw portion provided on an outer peripheral side of the portion overlapped with the outer race, in the radial direction relative to the rotation axis of the nut, and
wherein the housing includes a female screw portion which is screwed with the male screw portion.

4. The power steering apparatus according to claim 3, wherein the fixing member includes a tool engagement groove that is a tool engagement groove provided on an inner side of the fixing member in the radial direction relative to the rotation axis of the nut, and which engages with a fastening tool at a time when the male screw portion of the fixing member is screwed to the female screw portion of the housing.

5. The power steering apparatus according to claim 4, wherein the fixing member includes a partition wall for suppressing leakage of lubricant applied to the ball bearing, the partition wall which is provided between the tool engagement groove and the ball bearing in the direction of the rotation axis of the nut.

6. The power steering apparatus according to claim 4, wherein the tool engagement groove is a concave portion opened toward the nut-side pulley in the direction of the rotation axis of the nut.

7. The power steering apparatus according to claim 3, wherein the fixing portion is a screw including a male screw portion which overlaps with the outer race in the direction of the rotation axis of the nut.

8. The power steering apparatus according to claim 2, wherein, in the radial direction relative to the rotation axis of the nut, the housing is provided with an outer race radial facing surface which faces the outer race, and a fixing member radial facing surface which faces the fixing member, and
wherein, in the radial direction, a clearance between an inner peripheral surface of the fixing member and an outer peripheral surface of the outer race is larger than a clearance between the outer peripheral surface of the outer race and the outer race radial facing surface.

9. The power steering apparatus according to claim 1, including an annular wave washer for urging the outer race in the direction of the rotation axis of the nut, the wave washer which is provided between the facing portion of the fixing member and the outer race in the direction of the rotation axis of the nut, and
wherein the wave washer is formed with convex portions projecting and concave portions recessed in the direction of the rotation axis of the nut which are alternately arranged around the rotation axis of the nut.

10. The power steering apparatus according to claim 9, wherein the housing includes an axial direction regulating portion which faces an end surface of the fixing member in the direction of the rotation axis of the nut.

11. The power steering apparatus according to claim 1, wherein a circlip for regulating a position of the fixing portion with respect to the housing in the direction of the rotation axis of the nut is provided,
wherein the fixing portion is a plate-like portion extending to an outer side of the facing portion in the radial direction relative to the rotation axis of the nut,
wherein the housing is provided with a circular arc circlip engagement groove provided on an inner peripheral side of the housing, and extending in a direction around the rotation axis of the nut, and
wherein the circlip engages with the circlip engagement groove, and is disposed so as to come in contact with the plate-like portion.
